(19) United States
(12) Patent Application Publication
(10) Pub. No.: US 2022/0286564 A1
(43) Pub. Date: Sep. 8, 2022

(54) Method and Apparatus for Dynamic Realtime Sharing of Credit Units for Online Charging

(71) Applicant: Telefonaktiebolaget LM Ericsson (publ), Stockholm (SE)

(72) Inventors: Ramanathan Oppilamani, Chennai (IN); Rameshwaran Thulasidoss, Chennai (IN)

(21) Appl. No.: 17/637,964

(22) PCT Filed: Sep. 5, 2019
(86) PCT No.: PCT/SE2019/050832

§ 371 Date: Feb. 24, 2022

(51) Int. Cl. H04M 15/00; H04W 4/24

(52) U.S. Cl. CPC H04M 15/64; H04M 15/7652; H04M 15/852; H04M 15/854; H04W 4/24

(57) ABSTRACT

Dynamic adjustment of consumption limits governing the consumption of credit units from a “provider account” (24) offers numerous advantages in the context of Online Charging (OC), both to the involved communication network operator(s) and to the users or applications associated with the UEs (12) that use communication services subject to credit availability in the provider account (24). Specifically, two or more “consumer” accounts (26), each associated with one or more UEs (12), consume credit units from the provider account (24), for authorizing communication-usage by the associated UE(s) (12), subject to a respective consumption limit, which may be regarded as defining an allocated share of the credit units in the provider account (24), for use by the consumer account (26). Adjusting the consumption limits one or more times during the validity period of the credit units offers the opportunity to rebalance the credit allocations, such as in view of aggregate rates or amounts of consumption or consumption imbalances.

### TECHNICAL FIELD

The present invention relates to the sharing of credit units by multiple consumers, for authorizing communication-service use by the associated consumer equipment in a communication network.

### BACKGROUND

Chargeable use of a communication service by a User Equipment (UE) accessing service via a communication network depends on the real-time availability of “credit units” in one or more accounts linked to the UE. In a known arrangement, the UE links to a “consumer account” that in turn links to a “provider account” that contains credit units for consumption by the consumer account, for authorizing communication-service usage by the UE linked to the consumer account.

“Credit units” may be monetary or non-monetary, but in either case a “credit unit” can be understood as usable for authorizing a corresponding quantum of communication-service usage, e.g., amount, duration, etc. Although descriptions herein refer to “consumer accounts” and “provider accounts,” the consumer accounts are not necessarily credit-holding accounts. Instead, a “consumer account” may be a data record or credentials available to the involved charging system, linking one or more UEs to at least one provider account. The provider account is a credit-holding account from which the consumer account is authorized to consume credit units, for authorizing communication-service usage by the one or more linked UEs.

A non-limiting example having practical interest involves the kind of charging arrangements often seen in the context of corporations or families. A main account holds credit shared by multiple UEs, such as those owned or managed by a company, or UEs owned by employees of the company. Each UE or defined groups of the UEs are associated with respective consumer accounts, which may merely be subscription records or links to the main account, as a provider account. Similar arrangements provide families or other groups of people or UEs with a convenient mechanism for sharing credit units.

Sharing arrangement of the foregoing sort offers numerous advantages, both to the network operator(s) and the involved subscribers. As an example, linking a main account to multiple subordinate or related accounts simplifies account charging for the network operator and simplifies account replenishment and management for the involved subscriber(s). On the other hand, it is recognized herein that various problems and inefficiencies arise in such arrangements. As a particular recognition, the static sharing arrangements used conventionally lead to unnecessary denials or terminations of communication-service use.

### SUMMARY

Dynamic adjustment of consumption limits governing the consumption of credit units from a “provider account” offers numerous advantages in the context of Online Charging (OC), both to the involved communication network operator(s) and to the users or applications associated with the User Equipments (UEs) that use communication services subject to credit availability in the provider account. Specifically, two or more “consumer” accounts, each associated with one or more UEs, consume credit units from the provider account, for authorizing communication-usage by the associated UE(s), subject to a respective consumption limit, which may be regarded as defining an allocated share of the credit units in the provider account, for use by the consumer account. Adjusting the consumption limits one or more times during the validity period of the credit units offers the opportunity to rebalance the credit allocations, such as in view of aggregate rates or amounts of consumption or consumption imbalances. Corresponding advantages include preventing wastage of the credit units while avoiding unnecessary authorization refusals, allowing the users or applications associated with the UEs that use communication services to get revised quotas to continue ongoing communication-service sessions without termination.

In an example embodiment of a method performed by a network node of an Online Charging System (OCS) associated with a communication network, the method includes performing an initial allocation of credit units in a provider account that are subject to real-time sharing by two or more consumer accounts, for online charging within a defined validity period. Performing the initial allocation includes setting respective consumption limits for the consumer accounts, each consumption limit allocating a respective percentage of a starting balance of credit units to a corresponding one of the consumer accounts, for authorizing communication service usage in the communication network by a User Equipment (UE) linked to the consumer account.

The example embodiment of the contemplated method further includes, responsive to fulfillment of a reallocation condition during the validity period, performing a reallocation of a then-remaining balance of credit units in the provider account. The reallocation involves, for example, (a) updating the respective consumption limits, each updated consumption limit allocating a respective percentage of the then-remaining balance of credit units to the corresponding one of the consumer accounts, and (b) determining the updated consumption limits in dependence on rates of consumption or amounts of consumption across the consumer accounts, since the initial allocation or since a last reallocation.

In a corresponding example embodiment, a network node is configured for operation in an OCS associated with a communication network. The network node includes communication circuitry comprising a wired or wireless communication interface for exchanging charging-related messages with one or more other network nodes in the OCS or the communication network, and processing circuitry that is operatively associated with the communication circuitry.

The processing circuitry is configured to perform an initial allocation of credit units in a provider account that are subject to real-time sharing by two or more consumer accounts for online charging within a defined validity period, by setting respective consumption limits for the consumer accounts, each consumption limit allocating a respective percentage of a starting balance of credit units to a corresponding one of the consumer accounts, for authorizing communication service usage in the communication network by a UE linked to the consumer account. Further, the processing circuitry is configured to perform a reallocation of a then-remaining balance of credit units in the provider account, in response to fulfillment of a reallocation condition during the validity period.

For the reallocation, the processing circuitry is configured to update the respective consumption limits, and determines the updated consumption limits in dependence on rates of consumption or amounts of consumption across the consumer accounts, since the initial allocation or since a last reallocation. Each updated consumption limit allocates a respective percentage of the then-remaining balance of credit units to the corresponding one of the consumer accounts.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of one embodiment of an Online Charging System (OCS) included in or associated with a communication network.

FIG. 2 is a block diagram of example details for the OCS of FIG. 1, the example details illustrating one embodiment of a charging node of the OCS.

FIGS. 3 and 4 are diagrams of consumption tracking, in example cases involving three consumer accounts sharing credit units from a provider account.

FIG. 5 is a logic flow diagram of one embodiment of a method of operation by a charging node of an OCS.

FIG. 6 is a block diagram of another embodiment of a charging node of an OCS.

### DETAILED DESCRIPTION

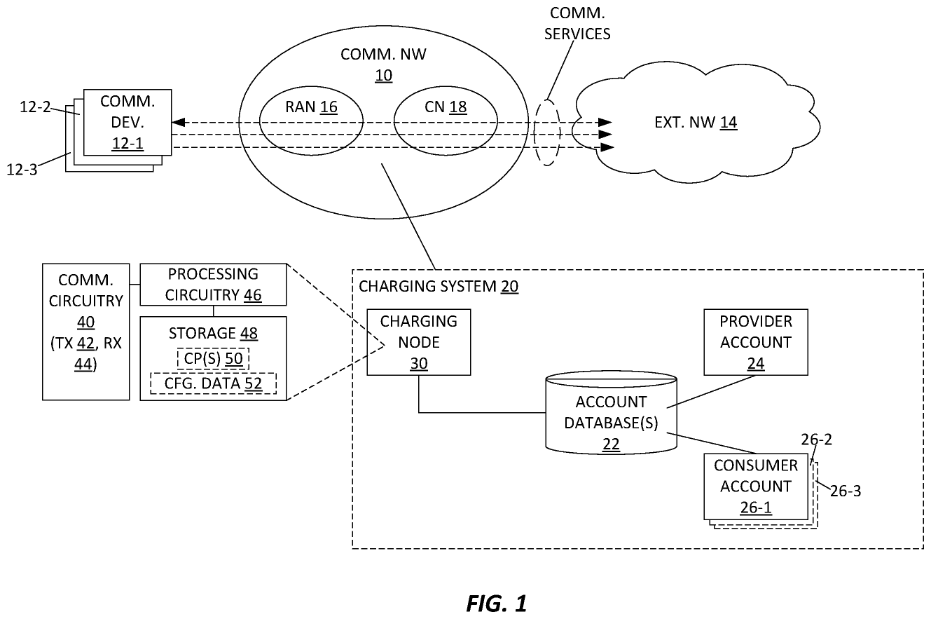

FIG. 1 illustrates an example communication network 10 through which communication devices 12 access one or more communication services, such as may be available from servers, systems, or other devices accessible via the Internet or another external network 14. In the example case, the communication network 10 is a wireless communication network that includes a Radio Access Network (RAN) 16 that provides an air interface for communicatively coupling to the communication devices 12, which, in this particular example, include radio transceiver circuitry configured for communicating with the RAN 16, according to the applicable radio signal types, structure, timing, and protocols.

As a non-limiting example, the communication network 10 operates according to specifications promulgated by the Third Generation Partnership Project (3GGP), such as the specifications defining so-called Fourth Generation (4G) networks, referred to as Long Term Evolution (LTE) network. In that example, the RAN 16 is an Evolved Universal Terrestrial RAN (E-UTRAN) and its associated Core Network (CN) 18 may be an Evolved Packet Core (EPC). In another example, the communication network 10 operates according to the Fifth Generation (5G) specifications and the RAN 16 provides a New Radio (NR) interface.

Both in and apart from the 3GPP-based examples, the communication devices 12 may be referred to generically as User Equipments (UEs), to denote the fact that they use communication services provided by or through the communication network 10. While three communication devices 12-1, 12-2, and 12-3 appear in the diagram for example purposes, no limitation attends the example count, and the reference number “12” is used herein to refer to communication devices in the singular and plural senses and the suffixing is omitted where not needed for clarity.

Hereafter referring to any communication device 12 or communication devices 12 as a “UE 12” or as “UEs 12”, the term UE denotes any 3GPP or non-3GPP communication apparatus that is configured to use one or more types of communications services based on accessing the communication network 10. Non-limiting examples include smartphones and mobile computing devices associated with human users, along with network adaptors, computers, etc., which may or may not be associated with human users. Further included are any of the various Machine Type Communication (MTC) or Internet-of-Things (IoT) devices that often do not involve any human use or interaction, and instead support various machine-based operations, such as monitoring and control.

Moreover, the particulars of the communication network 10 and the UEs 12 that access it are not necessarily relevant to the charging operations of primary interest in this disclosure. For an example framework for those charging operations, FIG. 1 illustrates a charging system 20, which provides online charging in one or more example embodiments. “Online charging” denotes charging for communication-service use in real time, such as where the initiation or continuation of a call or other type of communication session requires that sufficient credit be available for reservation and charging. See ETSI TS 132 296 V15.0.0 (2018-July), for example details regarding online charging.

The charging system 20 includes or has access to one or more account databases 22 that include information for a provider account 24 and one or more consumer accounts 26 that are linked to the provider account 24 for sharing credit units in the provider account 24. Three consumer accounts 26-1, 26-2, and 26-3 are shown in the example case. Here, the reference number 26 may be used to refer to consumer accounts in the singular or plural sense and suffixing is used only when necessary for clarity.

A greater or lesser number of consumer accounts 26 than illustrated may “share” a provider account 24. As described in the background section of this disclosure, the consumer accounts 26 may not be credit-holding accounts per se. For example, the consumer accounts 26 may be subscription records or other data that is logically linked to the provider account 24, for credit sharing. The provider account 24 may comprise or include a subscription maintained with a network operator that owns the communication network 10 or maintains a cooperative agreement with the operator of the communication network 10.

A network node 30, referred to hereafter as a “charging node 30”, stores or otherwise has access to the account databases 22. Here, it should be understood that the account databases 22 may or may not be centralized and that different portions of the account databases may be maintained by different computer servers. Similarly, the charging node 30 may be one node—e.g., one computer server—or may comprise multiple nodes, e.g., distributed at different locations in the charging system 20.

Whether implemented as a single node or implemented in a distributed arrangement, the contemplated charging node 30 includes communication circuitry 40 for communicating with other nodes in or external to the charging system 20. In a non-limiting example, the communication circuitry 40 includes one or more transmitter circuits 42 and one or more receiver circuits 44 that implement wired or wireless physical interfaces, for sending and receiving charging-related signaling. The communication circuitry 40 in at least one embodiment includes the physical-layer interface circuitry, along with one or more protocol processors, timing circuits, etc., for implementing the involved communication protocols and signaling.

Further included in the charging node 30 is processing circuitry 46, which may or may not use “virtualization” which involves the instantiation of virtualized processing resources using underlying processing hardware, as coordinated by the involved operating system and virtualization software. Even with virtualization, the processing circuitry 46 comprises physical circuitry that is fixed or programmed or some combination of fixed circuitry and programmed circuitry.

In one or more embodiments, the processing circuitry 46 comprises one or more microprocessors, digital signal processors (DSPs), field programmable gate arrays (FGPAs), complex programmable logic devices (CPLDs), or application-specific integrated circuits (ASICs), or any combination thereof. Further, in at least one such embodiment, the processing circuitry 46 is configured, at least in part, based on its execution of stored computer-program instructions.

Keeping in mind the above points of flexibility and variation, the contemplated charging node 30 is for operation in an Online Charging System (OCS) associated with a communication network, such as the charging system 20 in relation to the communication network 10. The charging node 30 includes communication circuitry 40 comprising a wired or wireless communication interface for exchanging charging-related messages with one or more other network nodes in the OCS or the communication network 10. Further, the charging node 30 includes processing circuitry 46 that is operatively associated with the communication circuitry 40. In at least one example case, referring to the processing circuitry 46 as being operatively associated with the communication circuitry 40 means that the processing circuitry 46 is arranged or otherwise configured to send and receive messages or other signaling, possibly of various types and involving more than one protocol, via the communication circuitry 40.

The processing circuitry 46 is configured to perform an initial allocation of credit units in a provider account 24 that are subject to real-time sharing by two or more consumer accounts 26 for online charging within a defined validity period. The processing circuitry 46 performs the initial allocation by setting respective consumption limits for the consumer accounts 26, each consumption limit allocating a respective percentage of a starting balance of credit units to a corresponding one of the consumer accounts 26, for authorizing communication service usage in the communication network 10 by UE 12 linked to the consumer account 26.

For example, three consumer accounts 26-1, 26-2, and 26-3 share the credit units in the provider account 24, according to respective consumption limits. Continuing the example, the consumer account 26-1 links to the UE 12-1, the consumer account 26-2 links to the UE 12-2, and the consumer account 26-3 links to the UE 12-3. Chargeable use of a communication service by the UE 12-1 would thus consume credit units from the provider account 24, based on the linking between the UE 12-1 and the consumer account 26-1 and the corresponding linking of the consumer account 26-1 to the provider account 24. Similar consumption linkages apply respectively to the UEs 12-2 and 12-3 and their corresponding consumer accounts 26-2 and 26-3. Of course, a consumer account 26 can be linked with more than one UE 12 and more than one type of UE 12, with one, all, or some of them authorized for the credit sharing contemplated herein.

Turning back to details of the processing-circuitry configuration, the processing circuitry 46 is configured to perform a reallocation of a then-remaining balance of credit units in the provider account 24, in response to fulfillment of a reallocation condition during the validity period of the credit units being shared. For the reallocation, the processing circuitry is configured to update the respective consumption limits. Each updated consumption limit allocates a respective percentage of the then-remaining balance of credit units in the provider account 24 to the corresponding one of the consumer accounts 26.

As a further aspect of the reallocation, the processing circuitry 46 is configured to determine the updated consumption limits in dependence on rates of consumption or amounts of consumption across the consumer accounts 26, since the initial allocation or since a last reallocation. That is, in some embodiments or in some circumstances, the charging node 30 performs, at most, one reallocation during the validity period of the involved credit units, while in other embodiments or in other circumstances, the charging node 30 performs multiple reallocations during the validity period.

In one example, the reallocation condition comprises an aggregate consumption of credit units from the provider account 24 reaching a configured threshold, the aggregate consumption being assessed with respect to the initial allocation or a last reallocation. As a practical but non-limiting example, if three consumer accounts 26-1, 26-2, and 26-3 are sharing credit units in a provide account 24 corresponding to ten gigabytes (GB) of data, an aggregate consumption threshold may be set, at least initially, at thirty percent of ten GB, e.g., three GB of data. Correspondingly, when the combined data usage of the UEs 12-1, 12-2, and 12-3 corresponding to the consumer accounts 26-1, 26-2, and 26-3 reaches three GB, the processing circuitry 46 performs a reallocation of the then-remaining balance of credit units in the provider account 24.

In another embodiment, or under other operating conditions, the reallocation condition comprises the aggregate consumption by the two or more consumer accounts 26 sharing credit units from the provider account 24 reaching a defined threshold and the respective shares of the aggregate consumption being out of balance across the two or more consumer accounts 26 by more than a defined amount. In at least one example, such an arrangement can be understood as having two reallocation conditions that must be satisfied simultaneously—i.e., the aggregate consumption across the involved consumer accounts 26 must reach a defined aggregate consumption threshold and the imbalance in consumption across the involved consumer accounts 26 must reach a defined imbalance threshold.

Further, in embodiments where the processing circuitry 46 is configured to perform more than one reallocation, as needed, over the validity period of the credit units being shared from the provider account 24, the processing circuitry 46 in at least one such embodiment is configured to adapt the aggregate consumption threshold or the defined imbalance threshold, or both thresholds. For example, the processing circuitry 46 adapts one or both thresholds as a function of the then-remaining balance of credit units in the provider account 24 or as a function of the then-remaining validity time of the credit units in the provider account 24, or as a function of both variables. The use of adaptable thresholds for triggering subsequent reallocations within the overall validity period of the involved credit units in the provider account 24 provides the processing circuitry 46 with a mechanism for more or less aggressive reallocations after an initial reallocation, in dependence on how much time is left in the validity period and/or in dependence on the remaining credit balance in the provider account 24.

Using lower thresholds makes reallocation more aggressive. As such, the threshold(s) used for triggering reallocation may be stepped or scaled down towards the end of the validity period, to make reallocations more aggressive towards the end of the validity period, as compared to the initial or prior reallocation(s), based on larger threshold(s). Similarly, the threshold(s) can be made smaller as the remaining balance of credit units in the provider account 24 decreases, to lessen the chance of unused credit units at the end of the validity period.

Broadly, in one or more embodiments, the processing circuitry 46 is configured to modify the reallocation condition in conjunction with performing a reallocation, such that the reallocation condition changes in type or value across subsequent reallocations performed within the validity period. Also, as noted, the reallocation condition for triggering any such reallocation is satisfied in one or more embodiments when an aggregate consumption of credit units from the provider account 24 by the consumer accounts 26 sharing the provider account 24 reaches a defined threshold. Correspondingly, the processing circuitry 46 is configured to track consumption of credit units from the provider account 24, subsequent to the initial allocation, to detect satisfaction of the reallocation condition.

In another embodiment, or under another operating scenario, the reallocation condition comprises a consumption imbalance across the two or more consumer accounts 26 reaching a defined threshold. As an example, the processing circuitry 46 is configured to assess the imbalance in terms of rates or amounts of consumption of credit units from the provider account 24. Here, the updated consumption limits determined by the processing circuitry 46 account for the imbalance by reallocating credit units in the provider account 24 that are currently allocated for use by an under-consuming one or ones of the two or more consumer accounts 26, for use by an over-consuming one or ones of the two or more consumer accounts 26. The processing circuitry 46 is configured to deem any given one of the two or more consumer accounts 26 to be under-consuming or over-consuming in dependence on a comparison of levels or rates of consumption across the two or more consumer accounts 26 that are sharing the credit units in the provider account 24.

In a related example, the reallocation condition is satisfied when, at least during a first portion of the validity period, at least one of the consumer accounts 26 is deemed to be over-consuming its initial allocation of credit units from the provider account 24, and at least one other one of the consumer accounts 26 is deemed to be under-consuming its initial allocation of credit units from the provider account 24. The processing circuitry 46 is configured to perform the reallocation by reallocating one or more credit units in the provider account 24 that were allocated for use by the at least one under-consuming consumer account 26, for use by the at least one over-consuming consumer account 26.

As another example, the processing circuitry 46 in at least one embodiment is configured to track consumption trends across the consumer accounts 26 with respect to the starting balance of credit units in the provider account 24 and perform reallocation(s) more or less aggressively in view of tracked consumption trends. For example, the processing circuitry 46 may predict from tracked consumption trends that one or more consumer accounts 26 will not consume any more than a fraction of their initial allocations of credit units during the validity period, thus wasting the unused portions of those initial allocations. Correspondingly, the processing circuitry 46 may reallocate some or all of the projected unused portions of the initial allocations to one or more other consumer accounts 26 that have higher consumption trends.

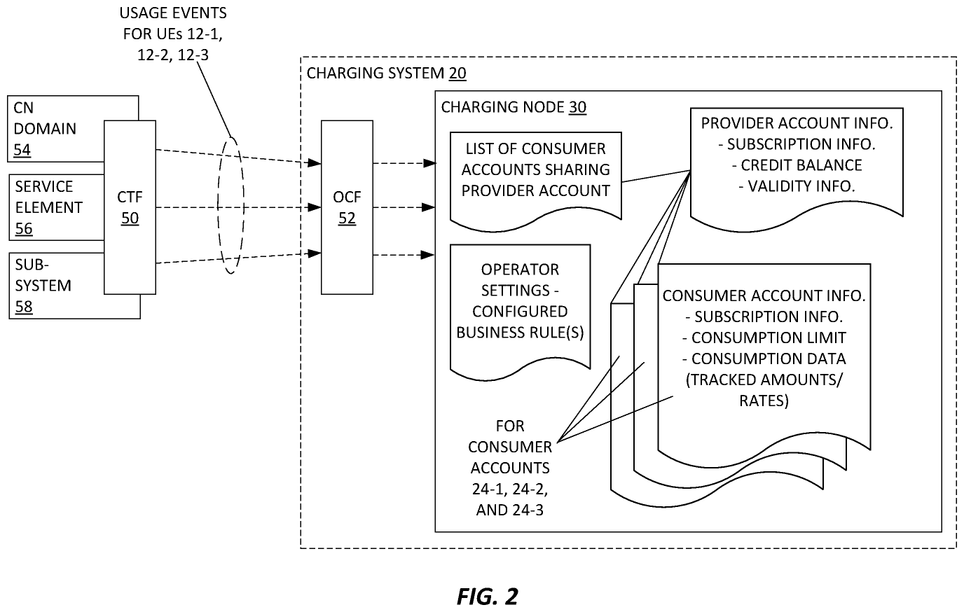

In at least some embodiments, the reallocation condition comprises a configured business rule, such as may be configured by an operator of the network 10 or the charging system 20. Further, the charging node 30 within the charging system 20 operates as, for example, an Account Balance Management Function (ABMF) within the charging system 20, for online charging. FIG. 2 provides a corresponding example arrangement.

In the illustrated example, the charging node 30 holds or has access to certain information, including a list of consumer accounts 26 that share a provider account 24. Correspondingly, the charging node 30 holds or has access to corresponding account information for the provider account 24 and the consumer accounts 26. Such information may include subscription information, including UE identifiers or other information, credit balances and corresponding validity information. At least some of this information may be generated or dynamically managed by the charging node 30, such as tracked amounts or rates of consumption of credit units from the provider account 24 by respective ones of the consumer accounts 26. And, as noted earlier, the charging node 30 may hold or have access to information representing one or more configured business rules, such as rules for when and how the charging node 30 performs reallocations of shared credit units.

As for detecting communication-service usage or attempts at usage authorization, the communication network 10 in an example embodiment comprises one or more Core Network (CN) domains 54 (e.g., an Evolved Packet Core or EPC), one or more service elements 56 (e.g., to provide Multimedia Services), and one or more subsystems 58 (e.g., IP Multimedia Subsystem). These various entities have associated Charging Trigger Functions (CTFs) 50 as integrated components, for collecting information pertaining to chargeable events and sending charging events for UEs 12 that are linked to the consumer accounts 26 that share the provider account 24. Correspondingly, the charging node 30 may receive signaling from the CTFs 50, or signaling corresponding thereto, via one or more Online Charging Functions (OCFs) 52.

Though the functional requirements for charging are broadly consistent across the various domains, services and subsystems, the reference point(s) between the CTF 50 and the OCF 52 depends on the domain, service, or subsystem involved in detecting communication-service usage. For example, a Circuit Switched (CS) domain uses CAMEL (Customized Applications for Mobile networks Enhanced Logic) as a reference point, whereas an IP Multimedia Subsystem (IMS) uses “Ro” as reference point between the CTFs 50 and the OCF 52. With regard to Diameter Charging Control (DCC), see IETF RFC 4006 and 3GPP TS 32.299 V8.9.0 (2009-December), the latter of which describes standardized interfaces between CTFs 50 and the OCF 52. Such interfaces may be used to “carry” charging-related signaling between the CTFs 50 and OCF 52. For further details regarding example charging architectures and principles associated with operation and interfacing of the CTFs 50, OCF 52, and the charging node in general, see 3GPP TS 32.240 V16.0.0 (2019-March).

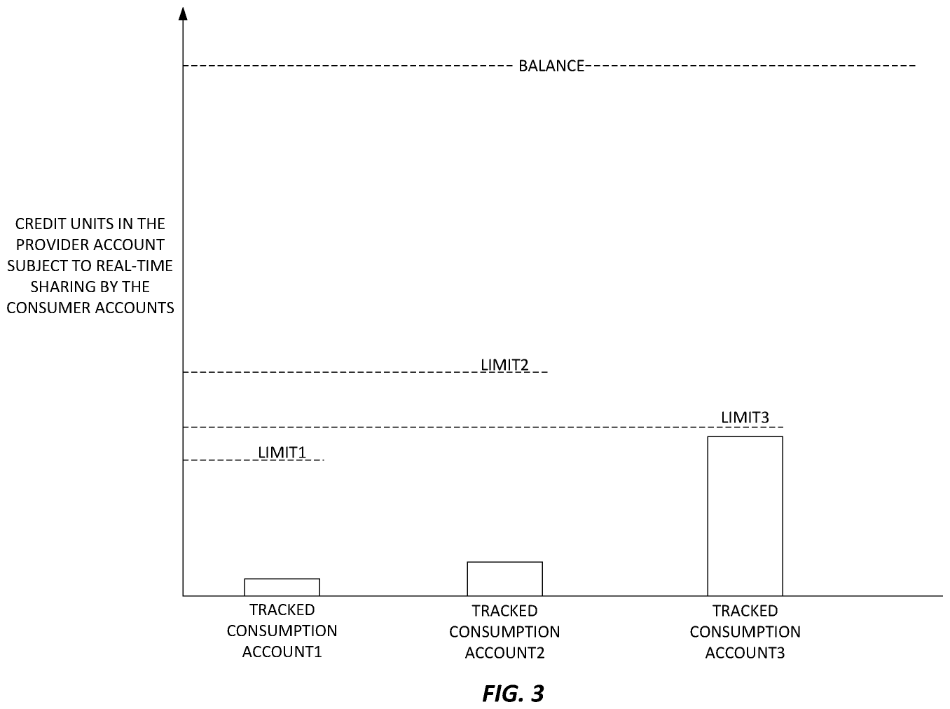

FIG. 3 is a bar chart representing consumption tracking performed by the processing circuitry 46 of the charging node 30, in at least one embodiment. The horizontal dashed line at the top of the chart represents either the initial or current balance of credit units in a provider account 24 that are shared by respective consumer accounts 26, denoted in the chart as “ACCOUNT1”, “ACCOUNT2”, and “ACCOUNT3”. The three horizontal lines respectively labeled as “LIMIT1”, “LIMIT2”, and “LIMIT3” represent corresponding consumption limits for ACCOUNT1, ACCOUNT2, and ACCOUNT3. These consumption limits may be initial consumption limits determined against a starting balance of credit units in the provider account 24, or they may be updated consumption limits determined against a current (then-remaining) balance of credit units in the provider account 24. In either case, the sum of the respective consumption limits normally equals the balance of credit units in the provider account 24.

Each one of the three bars shown in the chart reflects the tracked consumption for a corresponding one of the consumer accounts 26 sharing the credit units in the provider account 24. Consumption tracking uses, for example, the relevant metering unit for the involved communication service(s), e.g., megabytes, minutes, etc. Maintaining numerical representations of the tracked amounts of consumption by the respective consumer accounts 26 allows the processing circuitry 46 to assess both absolute and relative amounts of consumption by the respective consumer accounts 26 and assess, for example, whether given ones of the consumer accounts 26 are under-consuming or over-consuming relative to their respective consumption limits and/or relative to other ones of the consumer accounts 26.

In FIG. 3, ACCOUNT3 has a tracked consumption that is close to the consumption limit set for ACCOUNT3, meaning that the UE(s) 12 linked to ACCOUNT3 are at risk of being denied authorization to begin or continue using given communication services via the network 10, at least with respect to using shared credit from the provider account 24. On the other hand, neither ACCOUNT1 nor ACCOUNT2 is in any imminent risk of hitting their respective consumption limits.

In an example embodiment, the processing circuitry 46 performs a reallocation that alleviates the risk of credit exhaustion for ACCOUNT3, by reallocating one or more credit units in the provider account 24 that were previously allocated to ACCOUNT1 and/or ACCOUNT2, for use by ACCOUNT3. In this scenario, the reallocation condition is, for example, the aggregate consumption across ACCOUNT1, ACCOUNT2, and ACCOUNT3 reaching a defined threshold, or an imbalance in consumption among or across the consumer accounts 26 reaching a defined threshold, or both conditions being satisfied.

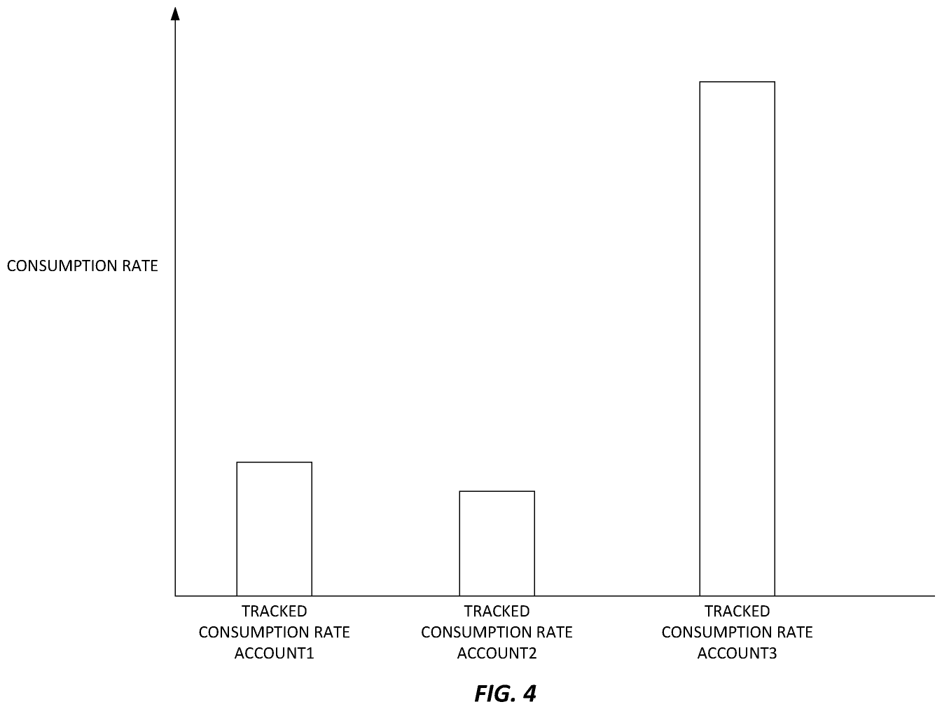

FIG. 4 depicts another example chart regarding consumption tracking by the processing circuitry 46 of the charging node 30. Unlike FIG. 3, FIG. 4 depicts the tracking of respective consumption rates for ACCOUNT1, ACCOUNT2, and ACCOUNT3. In an example embodiment, the processing circuitry 46 triggers reallocation of respective consumption limits for the consumer accounts 26 sharing credit units from the provider account 24, based on absolute or relative consumption rates. For example, in the chart, ACCOUNT3 has a high consumption rate, in comparison to ACCOUNT1 and ACCOUNT2, and the processing circuitry 46 may correspondingly deem ACCOUNT3 as being at risk of exhausting its allocation of credit units from the provider account 24, and perform a reallocation that allocates additional credit units from the provider account 24 to ACCOUNT3, at the expense of ACCOUNT1 and/or ACCOUNT2.

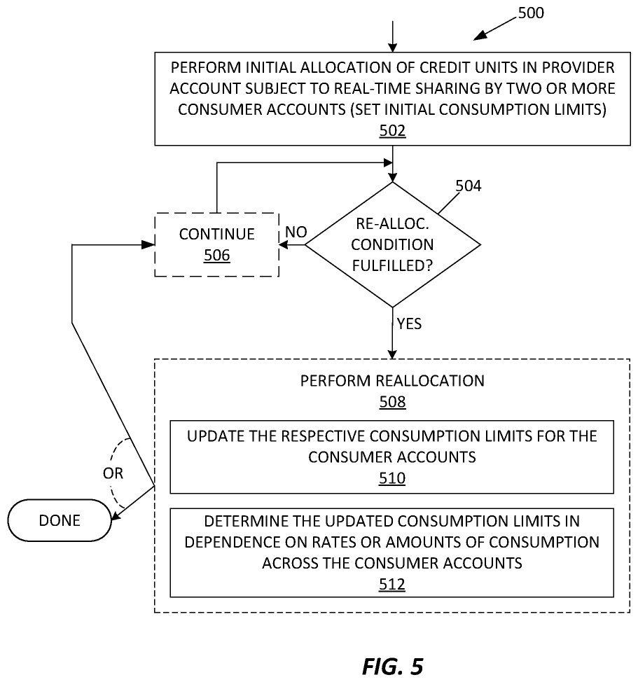

FIG. 5 illustrates a method 500 performed by a charging node 30, e.g., the processing circuitry 46 depicted in FIG. 1 for the charging node 30 is configured to carry out the operations or steps constituting the depicted method 500. However, the method 500 is not limited to the illustrated implementation of the charging node 30. Moreover, the method 500 may be performed as part of other, ongoing operations, and may be carried out with respect to multiple provider accounts 24, each provider account 24 being associated with two or more consumer accounts 26 sharing credit units from the provider account 24.

The method 500 includes the charging node 30 performing (Block 502) an initial allocation of credit units in a provider account 24 that are subject to real-time sharing by two or more consumer accounts 26 for online charging within a defined validity period. The charging node 30 performs the initial allocation by setting respective consumption limits for the consumer accounts 26. Each consumption limit allocates a respective percentage of a starting balance of credit units (in the provider account 24) to a corresponding one of the consumer accounts 26, for authorizing communication service usage in the communication network by a UE 12 linked to the consumer account 26. Of course, there may be multiple UEs 12 linked to one consumer account 26.

Further, responsive to fulfillment of a reallocation condition during the validity period (YES from Block 504), the method 500 includes performing (Block 508) a reallocation of a then-remaining balance of credit units in the provider account 24. The reallocation includes updating (Block 510) the respective consumption limits, each updated consumption limit allocating a respective percentage of the then-remaining balance of credit units to the corresponding one of the consumer accounts 26. Determining (Block 512) the updated consumption limits comprises determining them in dependence on rates of consumption or amounts of consumption across the consumer accounts 26, since the initial allocation or since a last reallocation.

In at least some embodiments, credit reservations against credit units in the provider account 24 are accounted for in assessing consumption. That is, a given credit reservation against credit units in the provider account for communication-service usage means that the reserved credit units are considered as “consumed.” More generally, assessing the number of credit units remaining in the provider account 24 and accounting for consumption from the provider account 24 accounts for credit reservations. One approach involves using reports of used credit units during re-allocation processing and, possibly, requesting additional reservations. In another approach, the re-allocation processing accounts for credit reservations by ensuring that credit reservations for respective ones of the consumer accounts 26 are preserved during any re-allocation of credit units.

If the reallocation condition is not satisfied (NO from Block 504), the method 500 continues without performing the reallocation. For example, the charging node 30 “continues” (Block 506) with any other needed or ongoing processing, such as consumption tracking, etc., while continuing to monitor for satisfaction of the reallocation condition (Block 504).

As previously noted, the reallocation condition may be a configured business rule, such as configured by a network operator associated with the network 10. In one example, the reallocation condition comprises the aggregate consumption of shared credit units from the provider account 24 reaching a defined threshold, which may be, at least for an initial reallocation, a configured percentage of the starting balance of credit units in the provider account 24 that are subject to sharing across the involved consumer accounts 26. In another example, the reallocation condition comprises an imbalance in amounts and/or rates of consumption across the consumer accounts 26 hitting a defined consumption imbalance threshold. In another embodiment, the reallocation condition is a combination of aggregate consumption reaching a corresponding threshold and consumption imbalance reaching a corresponding threshold.

In any case, the charging node 30 provides an advantageous mechanism for dynamically changing the sharing limits—consumption limits—of the two or more consumer accounts 26 that are sharing credit units from a provider account 24, during run time. Here, “run time” denotes live, ongoing operation of the network 10, including any usage or attempted usage of one or more communication services provided via the network 10, by any of the UEs 12 linked to the consumer accounts 26.

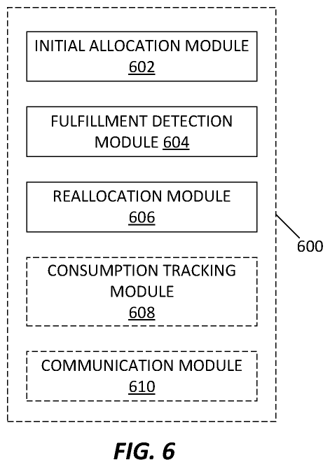

FIG. 6 illustrates another embodiment of a charging node 30, which is shown as a collection 600 of functional modules or processing units that are configured to carry out the operations described herein, in any one or more of the detailed embodiments. In one example, the collection 600 of functional modules is realized in or otherwise instantiated by the processing circuitry 46 of the charging node 30. However, as noted before, the charging node 30 and its included processing circuitry 46 may be distributed across more than one physical node or physical computing cluster, module, or platform, and may involve one or more levels of virtualization. As such, the collection 600 of functional modules may be implemented using physical computer-processing arrangements other than that depicted in the example of FIG. 1.

In any case, in an example arrangement, the collection 600 of functional modules includes an initial allocation module 602. The initial allocation module 602 is configured to perform an initial allocation of credit units in a provider account 24 that are subject to real-time sharing by two or more consumer accounts 26 for online charging within a defined validity period. For example, the initial allocation module 602 sets respective consumption limits for the consumer accounts 26, each consumption limit allocating a respective percentage of a starting balance of credit units to a corresponding one of the consumer accounts 26, for authorizing communication service usage in the communication network by a UE 12 linked to the consumer account 26.

The collection 600 of functional modules further includes a fulfillment detection module 604, which is configured to detect fulfillment of a reallocation condition during the validity period. Correspondingly, in response to such detection, a reallocation module 606 performs a reallocation of a then-remaining balance of credit units in the provider account 24. For example, the reallocation module 606 updates the respective consumption limits. Each updated consumption limit allocates a respective percentage of the then-remaining balance of credit units to the corresponding one of the consumer accounts 26. Advantageously, the reallocation module 606 determines the updated consumption limits in dependence on rates of consumption or amounts of consumption across the consumer accounts 26, since the initial allocation or since a last reallocation.

The collection 600 of functional modules may further include a consumption tracking module 608 that is configured to track rates or amounts of consumption on an aggregate basis with respect to a provider account 24 and/or on a per-account basis with respect to the two or more consumer accounts 26 that share credit units from the provider account 24. Still further, the collection 600 of functional modules may include a communication module 610 that is configured for communicatively coupling the charging node 30 to one or more other nodes in the charging system 20 and/or in the network 10.

Among the many advantages provided by operation of the charging node 30 in one or more embodiments is the dynamic adaptation of the respective consumption limits based on a configurable reallocation condition. For example, the reallocation condition comprises an aggregate consumption threshold from the provider account 24, a consumption imbalance threshold relating to imbalances in consumption from the provider account 24, specific dates, days, or times, or any combination of the foregoing, or essentially any other configurable business rule pinned to one or more variables of the network operator's choosing. For example, a network operator may configure the reallocation condition in dependence on the involved market offerings, which may consider the type(s) of involved communication services, promotional campaigns, the involved subscribers associated with the provider account 24 and/or the consumer accounts 26 that share the provider account 24, etc.

Whatever the basis or bases of dynamic adaptation of the consumption limits that govern consumption of shared credit units from a provider account 24 by respective ones among two or more consumer accounts 26 sharing the credit units, the dynamic adaptation provides a mechanism for avoiding the wasting of credit units and avoiding unnecessary denials or cessations of communication services to the UEs 12 that are linked to the consumer accounts 26 sharing credit units from the provider account 24. These benefits accrue to the network operator while still providing the network operator with the ability to impose or maintain fairness in consumption by the consumer accounts 26 sharing credit units from a provider account 24.

For example, a network operator may configure the charging node 30 to perform an initial reallocation within the validity period of the credit units being shared, but not any further reallocations within the validity period. Such an approach provides one “pass” or “attempt” by the charging node 30 to shift the credit allocations among the respective consumer accounts 26, to avoid having one or more of the consumer accounts 26 exhaust their respective allocations while one or more other ones of the consumer accounts 26 waste a portion of their respective allocations. Other mechanisms for imposing fairness involve adapting the reallocation condition for one or more subsequent reallocations within the validity period, to the extent that subsequent reallocations are permitted.

Broadly, the techniques disclosed herein define a solution for dynamically changing the consumption limits respectively imposed on the two or more consumer accounts 26 that are sharing credit units from a provider account 24. The techniques make sharing more flexible, by making the criteria or criterion for performing a reallocation—an updating of the consumption limits—configurable as a business rule that can be set by the network operator or other interested party having authorized access to the charging node 30 or the information database(s) used thereby.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-19. (canceled)

20. A method performed by a network node of an Online Charging System (OCS) associated with a communication network, the method comprising:
performing an initial allocation of credit units in a provider account that are subject to real-time sharing by two or more consumer accounts for online charging within a defined validity period, by setting respective consumption limits for the consumer accounts, each consumption limit allocating a respective percentage of a starting balance of credit units to a corresponding one of the consumer accounts, for authorizing communication service usage in the communication network by a User Equipment (UE) linked to the consumer account; and
responsive to fulfillment of a reallocation condition during the validity period, performing a reallocation of a then-remaining balance of credit units in the provider account, by:
updating the respective consumption limits, each updated consumption limit allocating a respective percentage of the then-remaining balance of credit units to the corresponding one of the consumer accounts; and
determining the updated consumption limits in dependence on rates of consumption or amounts of consumption across the consumer accounts, since the initial allocation or since a last reallocation.

21. The method of claim 20, wherein the reallocation condition comprises an aggregate consumption of credit units from the provider account reaching a configured threshold, the aggregate consumption assessed with respect to the initial allocation or a last reallocation.

22. The method of claim 21, wherein the reallocation condition further comprises respective shares of the aggregate consumption being out of balance across the two or more consumer accounts by more than a defined amount.

23. The method of claim 20, wherein the reallocation condition comprises a configured business rule.

24. The method of claim 20, wherein the reallocation condition comprises a consumption imbalance across the two or more consumer accounts reaching a defined threshold, the imbalance assessed in terms of rates or amounts of consumption of credit units from the provider account, and wherein the updated consumption limits account for the imbalance by reallocating credit units in the provider account that are currently allocated for use by an under-consuming one or ones of the two or more consumer accounts, for use by an over-consuming one or ones of the two or more consumer accounts, wherein a given one of the two or more consumer accounts is deemed to be under-consuming or over-consuming in dependence on a comparison of levels or rates of consumption across the two or more consumer accounts.

25. The method of claim 20, wherein the reallocation condition comprises a consumption imbalance between or among the two or more consumer accounts reaching a defined threshold.

26. The method of claim 20, further comprising modifying the reallocation condition in conjunction with performing the reallocation, such that the reallocation condition changes in type or value across subsequent reallocations performed within the validity period.

27. The method of claim 20, wherein the reallocation condition is satisfied when an aggregate consumption of credit units from the provider account by the consumer accounts sharing the provider account reaches a defined threshold, and wherein the method includes tracking consumption of credit units from the provider account, subsequent to the initial allocation, to detect satisfaction of the reallocation condition.

28. The method of claim 20, wherein the reallocation condition is satisfied when, at least during a first portion of the validity period, at least one of the consumer accounts is deemed to be over-consuming its initial allocation of credit units from the provider account, and at least one other one of the consumer accounts is deemed to be under-consuming its initial allocation of credit units from the provider account, and wherein performing the reallocation comprises reallocating one or more credit units in the provider account that were allocated for use by the at least one under-consuming consumer account, for use by the at least one over-consuming consumer account.

29. A network node configured for operation in an Online Charging System (OCS) associated with a communication network, the network node comprising:
communication circuitry comprising a wired or wireless communication interface for exchanging charging-related messages with one or more other network nodes, in the OCS or the communication network; and
processing circuitry operatively associated with the communication circuitry and configured to:
perform an initial allocation of credit units in a provider account that are subject to real-time sharing by two or more consumer accounts for online charging within a defined validity period, by setting respective consumption limits for the consumer accounts, each consumption limit allocating a respective percentage of a starting balance of credit units to a corresponding one of the consumer accounts, for authorizing communication service usage in the communication network by a User Equipment (UE) linked to the consumer account; and
responsive to fulfillment of a reallocation condition during the validity period, perform a reallocation of a then-remaining balance of credit units in the provider account, wherein, for the reallocation, the processing circuitry is configured to:
update the respective consumption limits, each updated consumption limit allocating a respective percentage of the then-remaining balance of credit units to the corresponding one of the consumer accounts; and
determine the updated consumption limits in dependence on rates of consumption or amounts of consumption across the consumer accounts, since the initial allocation or since a last reallocation.

30. The network node of claim 29, wherein the reallocation condition comprises an aggregate consumption of credit units from the provider account reaching a configured threshold, the aggregate consumption assessed with respect to the initial allocation or a last reallocation.

31. The network node of claim 30, wherein the reallocation condition further comprises respective shares of the aggregate consumption being out of balance across the two or more consumer accounts by more than a defined amount.

32. The network node of claim 29, wherein the reallocation condition comprises a configured business rule.

33. The network node of claim 29, wherein the reallocation condition comprises a consumption imbalance across the two or more consumer accounts reaching a defined threshold, the imbalance assessed in terms of rates or amounts of consumption of credit units from the provider account, and wherein the updated consumption limits account for the imbalance by reallocating credit units in the provider account that are currently allocated for use by an under-consuming one or ones of the two or more consumer accounts, for use by an over-consuming one or ones of the two or more consumer accounts, wherein a given one of the two or more consumer accounts is deemed to be under-consuming or over-consuming in dependence on a comparison of levels or rates of consumption across the two or more consumer accounts.

34. The network node of claim 29, wherein the reallocation condition comprises a consumption imbalance between or among the two or more consumer accounts reaching a defined threshold.

35. The network node of claim 29, wherein the processing circuitry is configured to modify the reallocation condition in conjunction with performing the reallocation, such that the reallocation condition changes in type or value across subsequent reallocations performed within the validity period.

36. The network node of claim 29, wherein the network node is configured for operation as an account balance management function within the OCS.

37. The network node of claim 29, wherein the reallocation condition is satisfied when an aggregate consumption of credit units from the provider account by the consumer accounts sharing the provider account reaches a defined threshold, and wherein the processing circuitry is configured to track consumption of credit units from the provider account, subsequent to the initial allocation, to detect satisfaction of the reallocation condition.

38. The network node of claim 29, wherein the reallocation condition is satisfied when, at least during a first portion of the validity period, at least one of the consumer accounts is deemed to be over-consuming its initial allocation of credit units from the provider account, and at least one other one of the consumer accounts is deemed to be under-consuming its initial allocation of credit units from the provider account, and wherein the processing circuitry is configured to perform the reallocation by reallocating one or more credit units in the provider account that were allocated for use by the at least one under-consuming consumer account, for use by the at least one over-consuming consumer account.
